(19) United States
(12) Patent Application Publication
(10) Pub. No.: US 2012/0240206 A1
(43) Pub. Date: Sep. 20, 2012

(54) Configuration of a Data Collection Agent and Its Distribution System

(75) Inventor: GEORGE E. HOFFMAN, SAN JOSE, CA (US)

(73) Assignee: CARRIER IQ, INC., MOUNTAIN VIEW, CA (US)

(21) Appl. No.: 13/050,310

(22) Filed: Mar. 17, 2011

(51) Int. Cl. G06F 15/16; G06F 21/20

(52) U.S. Cl. 726/6; 709/227; 726/7; 709/217

(57) ABSTRACT

A wireless device user controls participation in a study panel. The device contains a data collection agent installed by the user, the manufacturer, or a distributor. The user enlists in a study panel. The essential steps include: a user obtains a panel identification identity and provides it to a data collection agent; the data collection agent receives the panel identification identity and uses it to initiate the transfer of a data collection profile. Upon receiving the data collection profile, the data collection agent on the wireless device is configured to participate in a specific study. The agent is controlled by the profile to record metrics and user selections, transform the data into a package, and transmit the package to a destination package reception server determined in the profile.

Related Applications: Ser. No. 11/175,857 filed 5 Jul. 2005 issued as U.S. Pat. No. 7,609,650 on Oct. 27, 2009 discloses data collection agents and data collection profiles. Other related applications with common assignee include: Ser. No. 11/117,5572, Ser. No. 12/346,370, Ser. No. 12/371,190, Ser. No. 12/371,204, Ser. No. 12/849,800, and Ser. No. 13/043,347.

### BACKGROUND

1. Field of the Invention

The present invention relates generally to recording network and device parameters on wireless devices and related systems. More particularly, exemplary embodiments of the invention concern systems and methods for using distributed wireless devices to collect information about communication networks and user interaction with applications and services of wireless devices.

2. Related Technology

Conventional approaches tend to emphasize the use of pre-configured data gathering software. While the software can be instructed to collect certain subsets of data, the software cannot be quickly revised or modified to accommodate rapidly emerging and changing conditions. That is, the software can only collect the data that was originally programmed to be collected and further, such data can only be collected in accordance with the conditions initially programmed. Thus, the capabilities of such software are constrained by the foresight of the programmer. Because it is simply not possible for a programmer to be able to anticipate the wide variety of usage conditions, problems and events that may occur in connection with wireless devices and their users, this lack of flexibility is a significant limitation on the richness of data which can be conveniently analyzed.

It has been recognized e.g. Douik U.S. Pat. No. 6,012,152 to gather data from network elements in a telecommunications mobile network. However, alarms, faults, and failures may not concern some survey participants and raise visibility of otherwise ignored inefficiencies. It has been known e.g. Hendrickson U.S. Pat. No. 6,754,470 to collect device and network parametric data by instrumenting wireless devices with data gathering software. It has been known e.g. Agarwahl 20090005002 to collect information about IP networking on portable devices. It has been known e.g. Gaffney 20080221968 to initiate interaction with user of portable devices upon triggers detected in monitored data.

In all cases above, the software was installed and the users selected based on an external criteria about the device, the network, or the user characteristics. This scales poorly and sample sizes above 4000 participants exceed conventional infrastructure for provisioning. In one preferred embodiment, the disclosure recommended that the wireless device be taken offline, i.e. cabled to a pc and reflashed, to install any iteration of the data gathering application. This seems too close to violation of warranty terms to become adopted by mainstream users.

In short, qualifying, selecting, and recruiting of panel members and equipping them with necessary instrumentation is expensive and slow. Updating a panel sample with new software to install revised data collection slows the response to any rapidly emerging and unanticipated problem. It is undesirable to require survey study organizers to provision multiple servers to support a variety of users. It is undesirable to require survey study participants to navigate among a plethora of servers to participate in their assigned panel. It is undesirable to require a survey study participant to reinstall a complete data gathering software application for each survey study they are invited to participate in. What is needed is a way to allow prospective panel members to control participation and to easily obtain the necessary resources. What is needed is a single distribution system for all panel participants and all survey study organizers which reuses stable components, and minimizes downloads and installations from one survey study to another.

It can be appreciated that what is needed is a more flexible system to conduct many diverse survey studies across a large population of users without generating, testing, provisioning, and installing hard coded data gathering software.

### SUMMARY OF AN EXEMPLARY EMBODIMENT OF THE INVENTION

A survey study is provided by installing a data collection agent in a wireless device which records metrics and user responses as set out in two or more separately provisioned data collection profiles. Each profile may be replaced with another profile for more details or for a different study. A data collection agent is installed on a wireless device. Only after the data collection agent receives a panel id from the user is a data collection profile requested and installed to configure the data collection agent.

Each survey study is provided with at least one data collection profile. The profile is executed by a data collection agent to record metrics inter alia about the wireless device, user behaviors, applications and service, the communication environment, or perhaps the user's opinions and preferences about the device, the applications or services. The data collection profile also specifies transformations, and schedules and destinations for uploading the transformed data.

A data collection agent enables receiving metrics according to a data collection profile. By registering, the user requests participation in a survey study. This provides some authentication information and privacy. There may be more than one survey study available. Possibly the user qualifies for a study by the configuration of the wireless device and the applications and services of interest to the user.

A data collection agent may observe and record data about applications, communications, and services as enabled by a user. If configured, the data collection agent may solicit user inputs about the quality or desirablity of interactions with the applications and services accessed on the wireless device. It may relate to activity when the device is not connected to a network or has lost connectivity with the network. The data collection agent, controlled by a data collection profile transforms the received metrics into a package and uploads to a package reception server, if appropriate. The data collection profile contains criteria based on the contents of a package to discard the package or to schedule the upload of package to a chosen destination. The user enables the data collection agent by providing a panel identification identity which the data collection agent then submits to initiate a download of a data collection profile. The user obtains a panel identification identity by registering for a study.

Exemplary embodiments of the systems and methods of the invention can be implemented by using wireless devices, wireless telephones and smartphones, to implement monitoring of device and network performance, user behaviors, preferences, and attitudes.

Survey studies define which metrics are to be recorded on the devices in response to specified conditions and events, as well as the conditions and events that cause the device to upload the recorded and transformed metrics. Conditions or events include any occurrence in the network or on the device inter alia: signal strength, a dropped call, hardware faults, software errors, application start or end, and possibly other input that the device can sense, such as gestures, or a user pressing a button on the device, application activity and user's subjective assessment of satisfaction.

Each data collection profile describes for a particular study what parameters should be captured, and what events will cause data to be captured, stored, and uploaded. The data collection profile is downloaded from a resource in the network to a data collection agent on the wireless devices if the user of the wireless device provides the data collection agent with a panel identification identity. In accordance with the instructions specified in the data collection profile, the data collection agent on the wireless devices receives, stores, packages and uploads the specified data to one of a plurality of destinations. These and other aspects of embodiments of the present invention will become more fully apparent from the following description and appended claims.

The present invention is a component of a system, apparatus and method for building a panel of users of a system of wireless communications. Qualifications may be selected from specific categories of hardware, software, state, and configuration. The agents in an embodiment may self-select or in an embodiment may report their current configuration state and receive a suitable profile. If selected for a plurality of studies, the agent receives at least one profile.

Each data collection profile determines which device characteristics quantify performance and how often and what conditions should be stored. The data collection profile may further determine which interactions between the user and software applications are monitored and record those user behaviors and/or attitudes.

A data collection agent supports each of a panel of wireless device users. In an embodiment, the data collection agent is installed by the user. In an embodiment, the data collection agent is installed by the carrier. In an embodiment, the data collection agent is installed by a device distributor. In an embodiment, the data collection agent is a component of the wireless device and is activated by the user, the carrier, or the distributor. This is done at the wireless device by obtaining a panel identification identity; and transmitting the panel identification identity to a panel profile server. Then the wireless device receives a data collection profile corresponding to the panel identification identity.

In an embodiment, the method provides for bootstrapping the configuration of an agent by the user entering a panel id when prompted by the agent. The agent is capable of supporting any present or future survey study by being configured by a data collection profile. In an embodiment, the user is incentivised to report data and participate in a panel by monetary rewards, minutes of airtime, or advanced functionality enabled within an application.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a wireless communications network in which the survey system may be practiced;

FIG. 2 illustrates a flowchart of a method;

FIG. 3 illustrates a flowchart of a method;

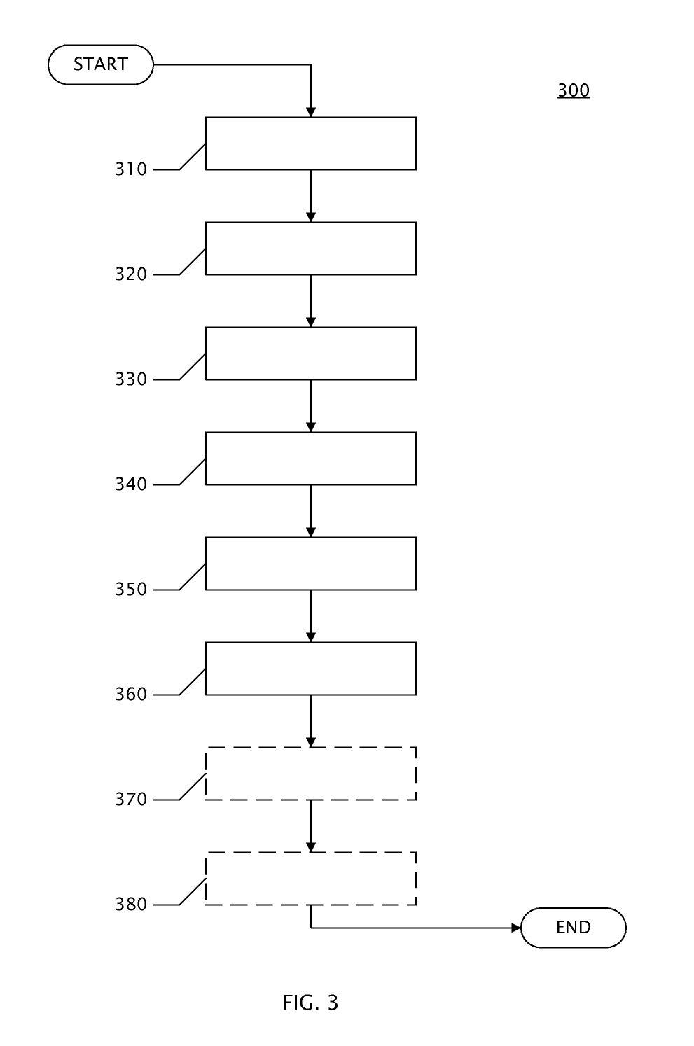

FIG. 4 illustrates a flowchart of a method; and

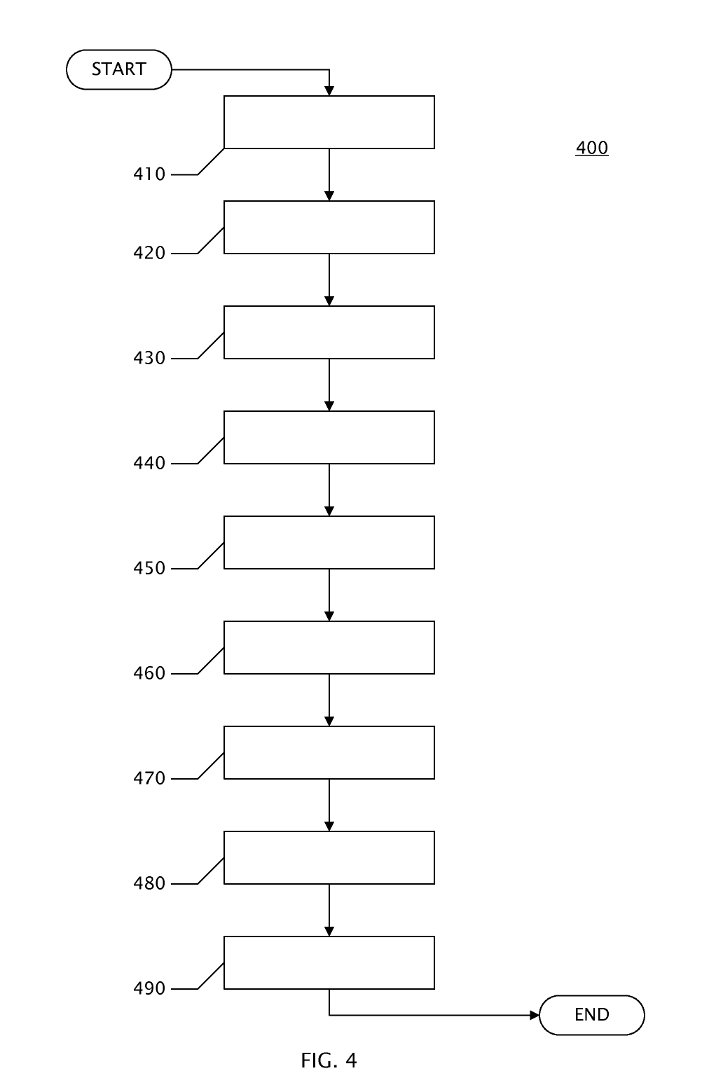

FIGS. 5A and 5B illustrates an apparatus embodiment of the invention.

### DETAILED DESCRIPTION OF EMBODIMENTS OF THE INVENTION

Reference will now be made to the drawings to describe various aspects of exemplary embodiments of the invention. It should be understood that the drawings are diagrammatic and schematic representations of such embodiments and, accordingly, are not limiting of the scope of the present invention, nor are the drawings necessarily drawn to scale.

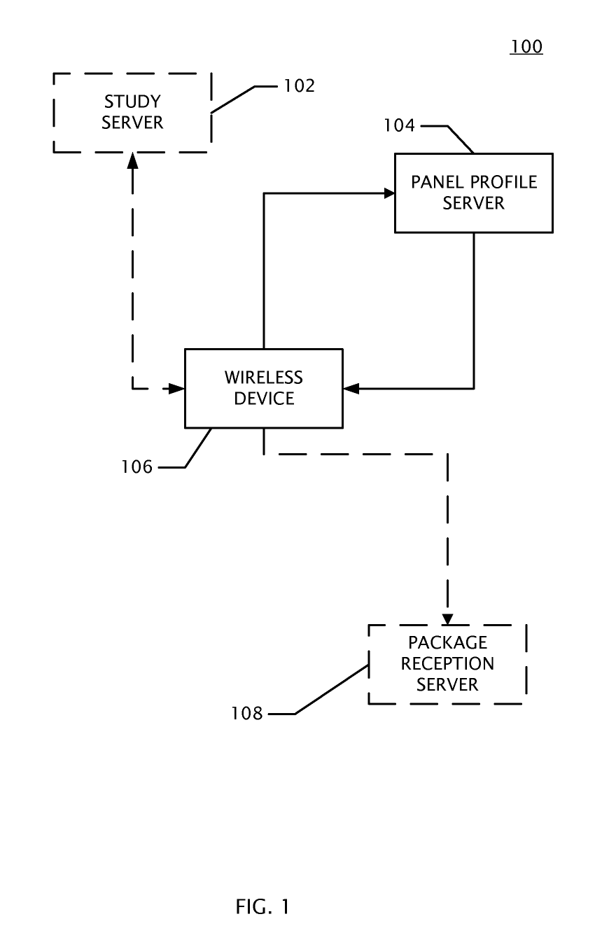

Accordingly, referring to FIG. 1 wireless network 100 includes or interfaces with all of the elements necessary to route circuit-switched telephone calls and/or packet data communication through the network. More specifically, the methods of the invention can be used in conjunction with a circuit-switched network, a packet data network, or both. While the exemplary embodiment of the invention uses Internet Protocol (IP) as its transport protocol, the methods of the invention may be implemented using other transport protocols, such as short message service (SMS) and Short Data Burst services that are well known in the art. Application servers or third party reporting systems (depicted as study server 102 in the exemplary embodiment), may reside outside network 100 and can be used in conjunction with the present invention. References herein to the terms “wireless network” or “the network” throughout should be construed as inclusive of the network infrastructure, servers, end user devices, and applications and services.

Wireless device 106 has a local memory that is used to locally store data and permits the execution of software such as an operating system and applications, and to otherwise support the operation of the wireless station. A variety of operating systems known in the art such as Android, iOS, and MobileWindows or any other suitable operating system may reside on the wireless device. In addition, wireless device 106 is enabled with a data collection agent that allows it to participate in survey activities by receiving and executing data collection profiles for a plurality of surveys. In an embodiment, a user obtains a panel identification identity from the study server 102. In an embodiment, a user also obtains a new or updated data collection agent from the study server or an other server in the network and installs it on the wireless device 106. However the data collection agent is installed, it receives a panel identification identity from the wireless device user and communicates it to a resource on the network, the panel profile server 104. The panel profile server initiates a process to download and install a data collection profile on the wireless device 106 which configures the data collection agent to record metrics, transform them into packages and transmit the packages to a package reception server 108 specified in the data collection profile.

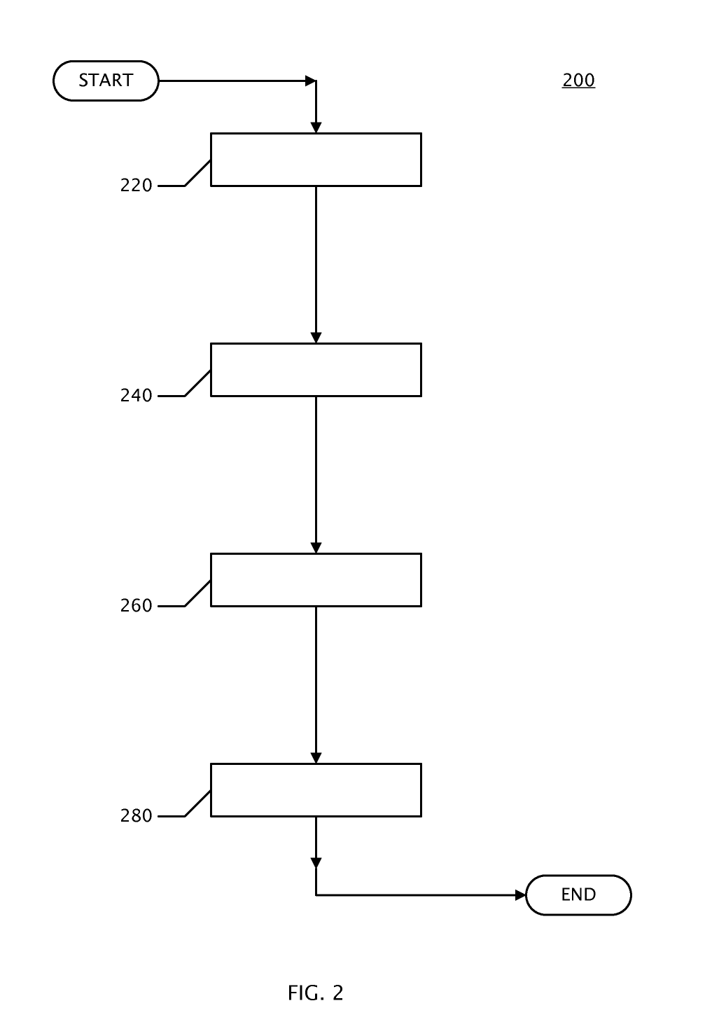

In an embodiment, referring now to FIG. 2, the invention controls a process 200 on a wireless devices to perform a method for requesting a data collection profile at a data collection agent of a wireless device. The method includes:
initiating 220 a connection across a communication network with a panel profile server upon the initiative of the wireless device user;
transmitting 240 an authentication credential and at least one panel identification id code for a survey study;
receiving 260 a data collection profile; and
enabling 280 the data collection agent to operate using the data collection profile.

The data collection profile may be, in one embodiment, a series of executable commands which may be executed by the data collection agent on the wireless device, the data collection profile defining a user survey and user inputs that are to be stored, and a condition under which the survey is to be launched and the inputs to be stored.

In an embodiment, the user logs in with an authentication credential, inter alia, a user id and password.

A data collection agent may be installed during product manufacture, in its distribution process, or in the field. For example, a user may initiate the method by selecting an application from a store, entering a uniform resource identifier in an address field, or clicking on a hyperlink in an SMS, email, tweet, or webpage which is a URI.

The objective of joining a survey study is to report and remark on services provided to a user of the wireless device. Participant may receive compensation or merely want to provide information to influence products and services.

An another embodiment a method 300 for storing metrics associated with survey responses across a plurality of devices proceeds as follows:
receiving 310, at a data collection agent of a wireless device, a data collection profile comprising a series of executable commands which are executed by the data collection agent, the data collection profile defining metrics and survey responses that is to be stored, a condition under which the metrics are to be stored and a survey launched, and conditions under which the stored metrics and survey responses are to be transformed and transmitted,
the data collection profile having been requested by the user of the wireless device based on an incentive to join a panel, problems encountered in previous usage, or membership as a survey participant in a study;
executing 320, by the data collection agent, the data collection profile;
determining 330, by the data collection agent at the wireless device, that a condition defined by the data collection profile has occurred;
storing 340, by the data collection agent, metrics at the wireless device in response to the condition and as specified by the data collection profile;
transforming 350 the stored metrics into a package; and
transmitting 360 the package to a package reception server 108 according to the conditions defined in the data collection profile.

One objective of a study may be related to services provided to a user of the wireless device. Or it could concern user preference in operating the device or using particular applications. To accomplish this the agent and the profile record characteristics of a software stack of the wireless device that communicates with various network layers of the communications network.

In addition to storing quantitative metrics, the invention may optionally provide a user survey to record opinions and reactions to the performance of the wireless device from the user's prospective. In this case the data relates to user selected values on a display of opinion survey choices. User input can be recorded from voice recognition of words or phrases, photographic images, keystrokes, button clicks, strokes on a touch pad or touch screen, and gestures from accelerometers or infrared sensors.

Storing the metrics at the wireless device can be performed also in response to a configuration of the wireless device being compatible with availability of the metric. That is, if a profile cannot be executed it is discarded. In this sense, a wireless device self-selects for a survey study and an external selection step is eliminated which increases parallelism. Instead of traversing a database of hundreds of thousands of wireless devices for a specific configuration, the wireless devices can each determine its own membership in or disqualification from a panel.

Characteristics that indicate that the wireless device is compatible with the storage of the metrics are inter alia: the ability of the device to store metrics specified in the profile; the ability of the device to respond to the triggers specified in the profile; the RAM storage on the device available for metrics storage; the non-transitory medium on the device available for storage of metrics packages; the processing power of the device; and the general ability of the device to execute the specified data collection profile.

In another embodiment, time is a selection criteria: specified collection profiles or metric receiving directives within the data collection profile become effective or disabled during one or more valid times. Or, specified collection profiles or metric receiving directives within the data collection profile are effective or disabled after a period of time from an event. In some cases, the installation of particular hardware or software places the wireless device into an interesting category, and thus the triggering condition is a particular wireless device configuration or history.

More limitations on the method include the steps: receiving 370 another data collection profile at the wireless device; and in response to determining, by the wireless device user, that said other data collection profile is not desirable, purging 380 said other data collection profile.

One aspect of the invention is that the wireless device has been selected by its user to enroll in a survey study and to receive the data collection profile by accessing a survey study database to determine that the wireless device has at least one characteristic that corresponds to the data collection profile.

In an embodiment, the user is incentivized to participate in the survey study by a payment, remuneration, or benefit calculated upon the responses to the registration process which qualifies the user to participate in one or more survey studies.

In some cases transmitting to the package reception server includes selecting a time and place for transmission based on a status of the wireless device. Uploading the recorded data may be arranged to control the impact on the user or the network while being timely: selecting a time for transmission is performed according to at least one of: rules defined by the data collection profile; and a requirement of an application of the wireless device or an operating system of the wireless device, or a bandwidth threshold of connectivity of the wireless device with a network.

Another embodiment 400 is the computer process:
receiving 410 at a wireless device a data collection agent;
obtaining 420 a panel identification identity from the user; and
transmitting 430 the panel identification identity to a panel profile server.

Following installation of an agent and transmitting the panel identification identity, one embodiment has the following processes:
receiving 440, at the data collection agent of wireless device, a data collection profile comprising a series of executable commands which are executed by the data collection agent, the data collection profile defining data that is to be collected, a condition under which the data is to be collected, and conditions under which the collected data is to be transmitted;
executing 450, by the data collection agent, the data collection profile;
determining 460, by the data collection agent at the wireless device, that a condition defined by the data collection profile has occurred;
collecting 470, by the data collection agent, metrics at the wireless device in response to the condition and as specified by the data collection profile;
transforming 480 the stored metrics into a package; and
transmitting 490 the package to a package reception server according to the conditions and destination defined in the data collection profile.

A data collection agent installed on a device executes survey study processes in response to “triggers” defined in the profile, which initiate and terminate survey study activities, as well as in response to other rules and instructions in the data collection profiles.

When received by a wireless device, the data collection profile is processed by the data collection agent. In some cases, the data collection profile may be stored as received, or integrated with or take the place of previously received data collection profile(s).

Rules in the data collection profile direct assignment of metrics to buffers and link triggers to generated metrics by matching the identifiers in the common aspects of the metrics data structure. Data collection profiles can be implemented that define survey rules, triggers and buffers for metrics requirements that arise after production and implementation of the agent.

This is an extendable metrics model which can be implemented both for third party applications integrated with the wireless device (such as browsers and or messaging applications) and for applications that are downloaded into virtual environments such as BREW or Java Virtual Machines. The virtual environment implements the programming interface for invocation by the application and functions as described above. Each time the interface is invoked the data structure is passed.

In some non-limiting exemplary data collection profiles, commands may initiate an interactive questionnaire in response to a trigger, which could be as simple as the time of day or arriving at a geographical location, or it can be a complex combination of conditions, such as time of day, geographical location, an encounter with a particular error, or a combination of any of the above conditions coupled with use or non-use of a particular service or application. In the below text, references to a profile refer to a data collection profile.

In an embodiment, a profile comprises executable program instructions in binary code, in interpretive code, in procedural code, or in 4^{th} generation language to manipulate data and metrics at the adaptive agent. The executable instruction may compress metrics into packages, summarize a series of events or behaviors, recognize a pattern, monitor a state machine, trigger an upload, change a destination uniform resource identifier, initiate a new package, change a package definition, mask or unmask portions of a profile to enable or disable subscribing to a datastream, enable or disable recording of parameters or behaviors, maintain a rolling history of observations, events, records, send notifications of an event, compute or trace.

A profile may be triggered to initiate storage of metrics or display an input screen by some threshold value or transient condition. A profile may be triggered in a bad cell area, an internal status bit being set, a certain frame error rate being passed, or a record of crash recovery. A profile may be selected to operate or to be installed in a device within a configuration having certain range of characteristics, internal status bits, transient event history, as well as location and calendar. A profile may prepare one or more packages for upload. Multiple profiles may coexist in one agent. A profile may adapt to different circumstances and record different performance parameters and user behaviors. A profile may determine that another profile is appropriate. A profile may trigger recording certain metrics and evaluations based on prior other recorded metrics and conditions.

A profile includes a schedule or trigger for upload, a fallback for upload failure, a destination Uniform Resource Identifier (URI) and a plurality of device metrics and user inputs to assemble into at least one package. In an embodiment the profile contains program code to perform computations or thresholds to determine if an upload is enabled or disabled. Program code within a profile may alter the selection or transformation of metrics or sense a sequence of events which trigger a specialized set of procedures or launch a user interface. The program code within a profile may determine the appropriate combination of metrics for a condition or state.

Each individual profile controls what an agent records, combines a plurality of metrics and recordations into at least one package. In an embodiment a profile can determine a schedule for uploading a package. At a first step in filtering, an agent controlled by a profile may discard data which is not useful.

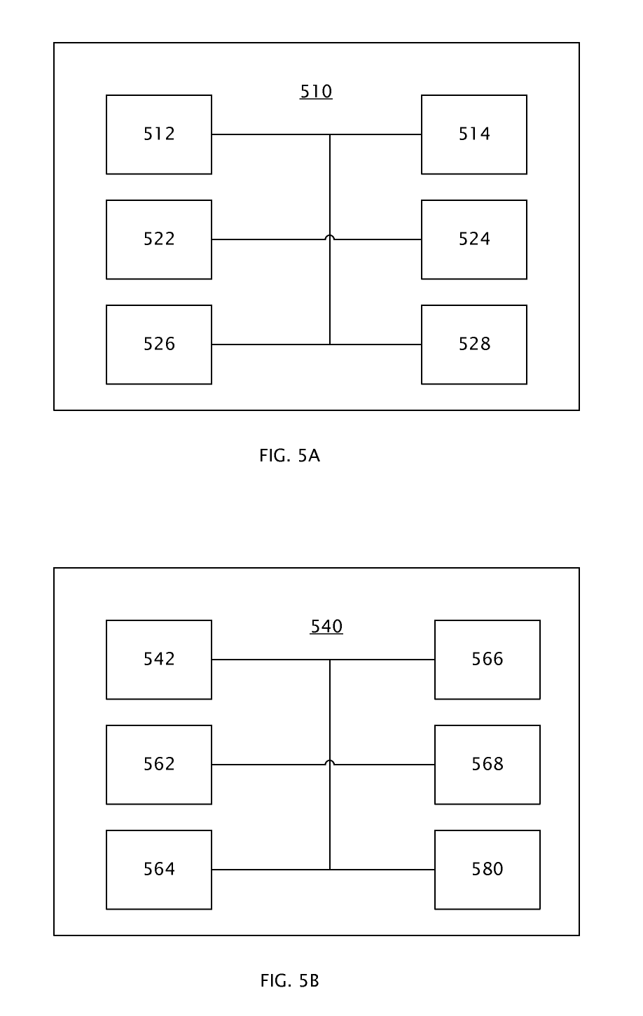

Referring to FIG. 5A, a wireless device 510 comprises: a processor 512 and a baseband chip 514, communicatively coupled to: a recorded data store 522, a panel identification identity store 524, a data collection profile store 526, and a data collection agent store 528. Referring to FIG. 5B a non-limiting exemplary server 540 may combine a processor 542 communicatively coupled to one or more of the following: a package store 562, a data collection profile store 564, a data collection agent store 566, a panel identification identity store 568 and a user registration database 580.

### Panel Selection

As mentioned previously, the data collection profile for a survey study can specify, include or otherwise incorporate other information, guidelines or rules concerning the data that is to be collected, as well as the conditions under which such data will be collected. Some data collection profiles include disqualification criteria that enable a wireless device to self-select or deselect in or out of the survey study. The data collection profiles may also include or specify various parameters concerning the hardware and/or software contained in, or associated with, one or more wireless devices.

In one embodiment in which wireless devices are used for a survey study, the qualification process includes methods to determine which wireless devices are incompatible with the data collection profile and must be disqualified from the data collection activity.

The invention can be understood in one non-limiting scenario: A plurality of wireless device users receives an invitation from a survey study organizer. After providing demographic screening information, inter alia the make and model number of the wireless device and applications and services in use, the user may be offered an incentive to participate, directions to download a data collection agent if not previously installed, and be assigned to a panel. In addition the user obtains a panel identification identity from the survey study organizer. By installing, updating, or activating the data collection agent and providing the data collection agent the panel identification identity, the wireless device user causes the agent to receive a data collection profile. The data collection profile defines metrics to be collected and transformed into a package and a destination to which the package is transmitted.

In other cases, the data collection profile can be defined in a way that captures the parameters and status of other services on the wireless device. The wireless device has many different services running on it, such as voice calls, messaging, games, and cameras. These services interact both on the device (contention for resources such as processor and battery) and in the network (contention for bandwidth). Thus, the growing number of potential interactions between these services, and the difficulty in analyzing all possible scenarios increase the need to better understand the customer experience.

### MEANS, EMBODIMENTS, AND STRUCTURES

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a non-transitory computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the claims.

### CONCLUSION

The present invention can be distinguished from conventional systems that do not provide a data collection profile to a data collection agent which may be reused with a plurality of data collection profiles corresponding to different survey studies. The present invention can be distinguished from conventional systems that do not provide a panel identification Id which enables a user with a data collection profile agent to obtain a data collection profile without having to access a variety of sources for different study surveys and avoiding the involuntary installation of a data gathering software on the user's wireless device. The present invention can be distinguished from conventional systems by user installation of a data collection agent on his personally owned wireless device at the user's discretion and without the permission or imposition of his carrier or his device supplier. The present invention is distinguished by providing a system for a variety of users, having different carriers and wireless devices, a way to install the necessary software for multiple survey studies from one convenient location rather than placing each study in a different location or directing users of one wireless device or carrier to one location different from users of an other wireless device or carrier. The present invention is easily distinguished from conventional systems by a data collection agent which is controlled by using a variety of data collection profiles for different surveys. Thus the survey data collected may be rapidly adjusted to changing usage and environments.

What is claimed is:

1. A method for requesting a data collection profile at a data collection agent of a wireless device, comprising:
initiating a connection across a communication network with a remote server upon the initiative of the wireless device user;
transmitting at least one panel identification identity code for a survey study;
receiving a data collection profile; and
enabling the data collection agent to operate using the data collection profile,
said data collection profile comprising a series of executable commands which may be executed by the data collection agent on the wireless device, the data collection profile defining data that is to be stored, and a condition under which the data is to be stored.

2. The method as recited in claim 1, further comprising transmitting an authentication credential.

3. The method as recited in claim 1, wherein the panel identification identity code was received by a user for a study survey.

4. The method as recited in claim 1, wherein the data relates to services and/or applications provided to a user of the wireless device.

5. A method for receiving metrics recorded at a plurality of wireless devices, the method comprising:
receiving, at a data collection agent of each wireless device, a data collection profile comprising a series of executable commands which are executed by the data collection agent, the data collection profile defining metrics and survey responses that is to be collected, a condition under which the metrics are to be recorded and a survey launched, and conditions under which the recorded metrics and survey responses are to be transformed and transmitted,
the data collection profile having been requested by the user of the wireless device based on a incentives to join a panel, problems encountered in previous usage, or membership as a survey participant in a study;
executing, by the data collection agent, the data collection profile;
determining, by the data collection agent at the wireless device, that a condition defined by the data collection profile has occurred;
storing, by the data collection agent, metrics at the wireless device in response to the condition and as specified by the data collection profile;
transforming the stored metrics into a package; and
transmitting the package to a package reception server according to the conditions defined in the data collection profile.

6. The method as recited in claim 5, wherein the metrics relate to services provided to a user of the wireless device.

7. The method as recited in claim 5, wherein the metrics relate to characteristics of a software stack of the wireless device that communicates with various network layers of the communications network.

8. The method as recited in claim 5, further comprising: receiving, at a wireless device, a data collection agent for installation by a wireless device user obtained by qualifying for participation in survey study.

9. The method as recited in claim 5, wherein collecting the data at the target device is performed also in response to a configuration of the wireless device being compatible with collection of the data.

10. The method as recited in claim 9, wherein characteristics that indicate that the wireless device is compatible with the storage of the metrics include at least one of: the ability of the device to receive metrics specified in the profile; the ability of the device to respond to the triggers specified in the profile; the RAM storage on the device available for metrics storage; the persistent storage on the device available for storage of packages; the processing power of the device; and the general ability of the device to execute the specified data collection profile.

11. The method as recited in claim 5, wherein specified collection profiles or data collection directives within the collection profile become effective or disabled during one or more valid times.

12. The method as recited in claim 5, wherein specified collection profiles or metrics storage directives with the collection profile are effective or disabled after a period of time.

13. The method as recited in claim 5, wherein the triggering condition comprises a particular wireless device configuration.

14. The method as recited in claim 5, further comprising: receiving another data collection profile at the wireless device; and in response to determining, by the wireless device user, that said other data collection profile is not desirable, purging said other data collection profile.

15. The method as recited in claim 5, wherein the wireless device has been selected by its user to enroll in a survey study and to receive the data collection profile by accessing a survey study database to determine that the wireless device has at least one characteristic that corresponds to the data collection profile.

16. A method for operating a study server to participate in a study comprising:
receiving registration and authentication information from a user of a wireless device;
qualifying said user for participation as a panel member of a survey study and providing a link to download a data collection agent for installation by the user on his wireless device; and
transmitting to said user a panel identification identity which enables the user to register for a study survey panel and receive a data collection profile which may be executed by the data collection agent to record metrics, transform metrics into packages, and transmit packages.

17. A method for operating a panel profile server comprising:
receiving from a data collection agent installed on a wireless device, a panel identification identity;
validating the panel identification identity for the user and for the wireless device from which the panel identification identity was transmitted; and
initiating transmission of a data collection profile associated with the study for which the panel identification identity applies.

18. A computer-implemented method comprising:
receiving from a user of a wireless device a panel identification identity at a data collection agent;
transmitting the panel identification identity to a panel profile server defined in the data collection agent.

19. The method of claim 18 for recording metrics associated with a wireless device, the method further comprising:
receiving, at a data collection agent of wireless device, a data collection profile comprising a series of executable commands which are executed by the data collection agent, the data collection profile defining metrics that are to be stored, a condition under which the metrics are to be stored, transformations of the metrics into a package, and conditions under which the package is to be transmitted;
executing, by the data collection agent, the data collection profile;
determining, by the data collection agent at the wireless device, that a condition defined by the data collection profile has occurred;
storing, by the data collection agent, metrics at the wireless device in response to the condition and as specified by the data collection profile;
transforming the stored metrics into a package; and
transmitting the package to a package reception server according to the conditions and at a destination defined in the data collection profile.

20. The method as recited in claim 18, wherein storing the metrics at the wireless device is performed also in response to a configuration of the wireless device being compatible with storage of the metrics.
